(19) United States
(12) Patent Application Publication
(10) Pub. No.: US 2005/0261612 A1
(43) Pub. Date: Nov. 24, 2005

(54) Vibrations driven through natural mammalian conduits for biofilm prevention

(76) Inventors: Zadick Hazan, Zichron Yakov (IL); Yanina Zumeris, Nester (IL); Jonas Zumeris, Nesher (IL)

Correspondence Address: MALINA & ASSOCIATES, P.C., Suite 501, 60 East 42nd Street, New York, NY, 10165, US

(21) Appl. No.: 11/131,315

(22) Filed: May 18, 2005

Related U.S. Application Data
(60) Provisional application No. 60/572,649, filed on May 18, 2004.

(51) Int. Cl. A61H 1/00

(52) U.S. Cl. 601/46; 601/2; 601/84

(57) ABSTRACT

A method is provided for decreasing amounts of foreign materials such as biofilm attached to internal anatomical surfaces of a mammalian body. The method includes attaching a nanovibrational energy resonator device onto an external or internal area of the body, the area being proximal to a mammalian conduit system and applying nanovibrational energy thereto.

### CROSS REFERENCES

This application claims priority from U.S. Application No. 60/572,649 filed May 18, 2004.

### BACKGROUND OF THE INVENTION

1. Field of the Invention

The invention concerns a method for elimination of biofilm deposits within or around internal human organs.

2. The Related Art

Many pathological conditions are caused by detachment of foreign materials which originate elsewhere depositing onto or around anatomical surfaces. Microorganisms such as bacteria are important contributors to the foreign materials. They deposit as biofilm attaching to mucuous membranes in the respiratory, urinary and digestive systems and on the lining of the vascular bed including veins and valves in the heart. Bacteria and other foreign material debris can also be found on the outside lining of the peritoneum and the pleura. Biofilms may deposit on the lining of bones, periost, muscles, the sarcolemma and tendons. Typical infections caused by the positioning of foreign materials or biofilms are pleuritis, poritonitis, periostitis, myositis, bursitis, tendonitis, vasculitis, bronchitis, pneumonitis, and otitis.

The attachment of blood cells, protein, bacteria and other biofilm materials to heart valves and to the lining of the vascular bed form coagules that frequently can detach and thereby cause an embolism (thrombosis). Attachment is more prone to occur at points along organs of the circulatory system where the surfaces are rough. At these rough points, the flow of blood is not of the normal laminary type.

It is clear that the attachment of these foreign exogenous or autogenous materials is of a physicochemical nature, i.e., ionic, hydrophobic, polar and/or electrostatic. The attachment can be specific or non-specific. By specific, it is meant that a foreign material is attached to a specific receptor.

The aforementioned processes sometimes evolve in a snowball fashion augmenting one another. For example, the attachment of bacteria can speed up coagulation because the bacteria serve as a nucleus for thrombus formation. Vice versa, a thrombus can serve as a focus for a bacterial invasion and consequently lead to infection. Once such a nucleus of endogenic or exogenic material has been established on the surfaces of the lining of the vascular bed, a material grows by virtue of the turbulent flow circumventing that material.

A special case is that of prosthetic devices implanted in the body. These materials attract attachment of cells of the immune system. In the vascular bed, these devices often cause the formation of coagulants which evolve into thrombi. The prosthetic material becomes coated by body proteins (conditioning) and by cells of the immune system and are tolerated by the body. Not infrequently after a period of tolerance, which can be years, the prosthetic device becomes infected or is fouled. A rejection reaction then occurs leading to a severe and even life threatening condition. The local physiology is altered and the local immunity is not always capable of controlling infections on the prosthetics. These complications lead to an increase in mortality and morbidity.

### SUMMARY OF THE INVENTION

The present invention is targeted at preventing the processes leading to the attachment of inert material, such as proteins or cells, to certain areas of the body where these pathological processes occur. Specifically, the present invention is a method for decreasing amounts of foreign materials attached to internal anatomical surfaces of a mammalian body, including attaching a nanovibrational energy resonator device onto an external or internal area of the body, the area being proximal to a mammalian conduit system and applying nanovibrational energy thereto.

According to the present invention, the nanovibrational energy has amplitudes ranging from about 1 to about 50 nanometers. Frequencies of the nanovibrational energy may range from about 0.1 Hz to 50 MHz. Nanovibrational energy can be generated simultaneously with at least two different frequencies. Piezo ceramic materials can be utilized as the resonator device.

A resonator device can be applied onto the neck of a mammalian body, particularly over the cricoid cartilage, commonly referred to as the Adam's Apple.

Mammalian conduits are not limited to but according to the present invention can cover member parts of certain bodily systems. These systems may be selected from the group consisting of respiratory, circulatory, skeletal, urinary and digestive systems.

The nanovibrational energy resonator device in certain aspects of the present invention may be inserted directly within the body. These insertions may either be through a bodily cavity, such as the mouth or rectum. Alternatively, an acoustical needle generating nanovibrations can be inserted through an incision into the body by laproscopic surgery.

Particularly useful is application of nanovibrational energy to the heart. Most especially, this energy may be applied to myocardial tissue or to valvular cuspids. Additionally, nanovibrational energy may be applied to a prosthetic member implanted into the body. Another target may be the lungs. Nanovibrational energy may also be applied to a mammalian brain.

An external mode in another embodiment of the present invention is to attach a nanovibrational energy resonator internally over one or more digits of a mammalian hand or foot.

### BRIEF DESCRIPTION OF THE DRAWING

Additional features and advantages of the present invention will become readily apparent from consideration of the following drawing in which:

FIG. 1 is a schematic illustration of various tissues which can serve as natural conduits for nanovibrational energy towards a target organ or internal area;

FIG. 2 is a schematic illustration of nanovibrations being transmitted downward to a target body;

FIG. 3 is a schematic illustration of a resonator actuating nanovibrations along the elementary canals;

FIGS. 4(a) and 4(b) are variants on the electrical system and controls involved in generating nanovibrational energy;

FIG. 5 is a schematic illustration of multidirectional energy transmission from an actuator or resonator;

FIG. 6 illustrates vibrational energy transmitted in a single direction;

FIG. 7 (a) through (f) illustrates a transmission scheme in a cascade through several internal objects;

FIG. 8 (a) through (c) illustrates three alternative arrangements for an embodiment of a resonator attached over the neck area of the body;

FIG. 9 illustrates body organs transmitting vibrational energy as natural conduits to lobes of the lungs, the latter being target organs;

FIG. 10 is a schematic illustration of external surfaces of a trachea to which nanovibrational energy is applied;

FIG. 11 is a schematic illustrating application of nanovibrational energy against an internal surface of the trachea;

FIG. 12 is an illustration of several natural conduits forming an acoustic junction;

FIG. 13 is an illustration of two different wave length nanovibrational energies being selectively transmitted to different targets along natural conduit pathways of the body;

FIGS. 14 and 14(a) illustrate transmission of nanovibrations from an external portion to an internal surface of the organ resulting from a transverse wave of mechanical energy;

FIGS. 15 and 15(a) illustrate transmission of nanovibrations through conductive fibers of the heart and the appearance of cells of the latter under microscope expansion;

FIG. 16 illustrates nanovibrational transmission to a spherical organ which serves as a concentrator of mechanical energy;

FIG. 17 illustrates application of the present method to a urinary system;

FIG. 18 illustrates local application of nanovibrational energy to a digit of the hand;

FIG. 19 illustrates the concept of transmitting through one finger digit selectively to another finger digit;

FIG. 20 illustrates the intestinal tract filled with special fluids or semi-solids for assisting specific acoustic conductive properties serving as intermediary for vibrational transmission;

FIG. 21 illustrates a encephalic vascular system; and

FIG. 22 illustrates an internal surface of shell (cranium) surrounding the brain, the shell conducting nanovibrational energy.

### DETAILED DESCRIPTION OF THE INVENTION

The invention provides a method for reducing and eliminating foreign materials which generally can be called biofilm for attachment onto internal anatomical surfaces. This result is achieved through nanovibrational energy applied adjacent to a target organ or adjacent to a natural body conduit transmitting the energy to the target. Target organs are selectively cleansed of biofilm through careful selection of the nanovibrational frequencies.

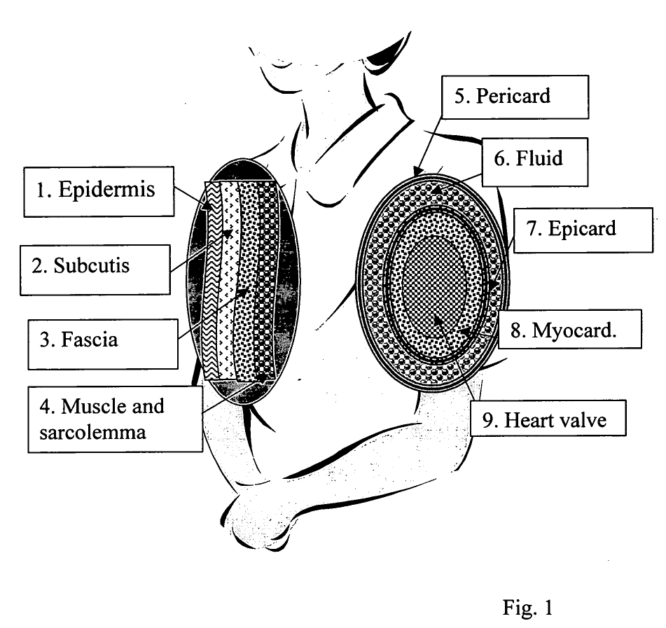

In a first embodiment of the present invention, the nanovibrational energy resonator device is placed on an external part of a mammalian body. FIG. 1 reveals several natural conduits in the body capable of transmitting the nanovibrational energy towards a target. These conduits include epidermis 1, subcutis 2, fascia 3, and muscle/sarcolemma 4.

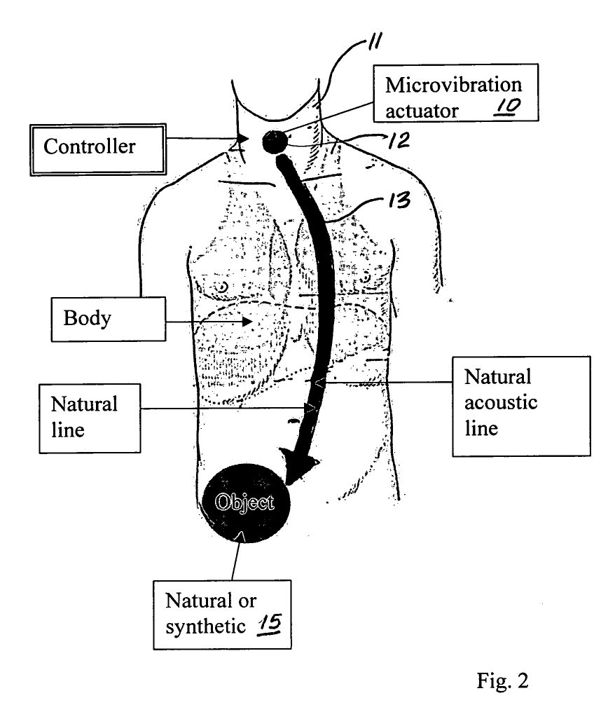

FIG. 2 illustrates external attachment of a nanovibrational actuator or resonator 10 placed on a neck area 11 directly over the Adam's Apple 12. The attachment of the actuator resonator 10 is made sufficiently firm to create pressure between the resonator and the cricoid cartilage forming the Adam's Apple. The vibrations are then delivered down the trachea 14 below the natural body conduit 13 to a natural body organ or a synthetic prosthetic 15.

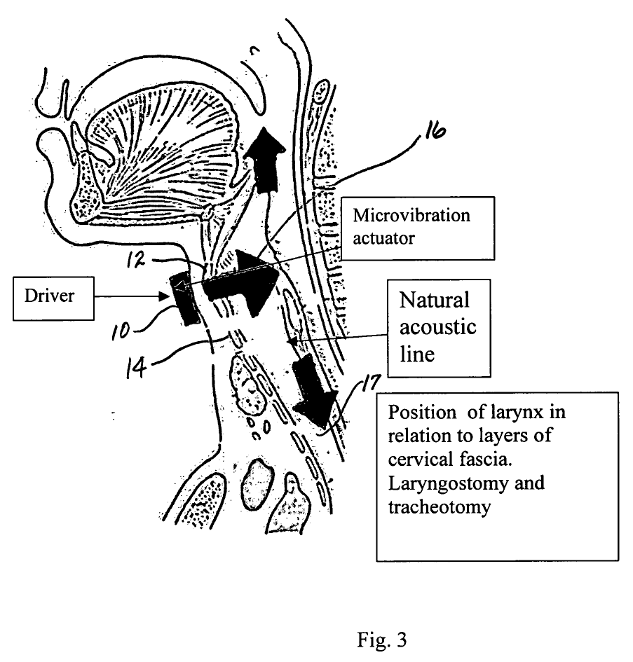

FIG. 3 illustrates in a cross-sectional view the concept of FIG. 2. Actuation of the resonator 10 generates nanovibrational waves 16 moving inward and then being distributed upward towards the nasal passages and also downward through the larynx along the natural body conduits. These vibrations may eventually reach an arch of the aorta and pulmonary artery and propagate through these vessels to respective heart valves. All the heart valves are connected to a fibro-elastic tissue that separates two ventricles from the atriae. These structures, the valves and the fibrous heart skeleton, are effective transmitters of vibrations representing ideal natural conduits. FIG. 1 illustrates various heart-related conduits including the perigard 5, blood fluid 6, epicard 7, myocard 8 and heart valves 9.

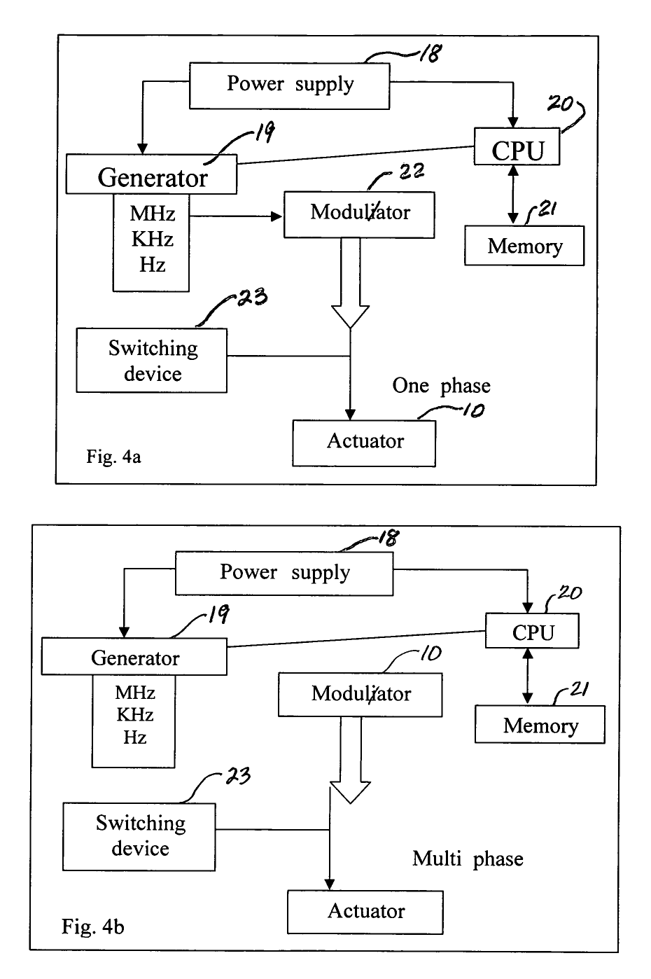

FIG. 4 (a) is a schematic grid of an electrical system controlling operation of an actuator or resonator 10. The power supply 18 transmits electrical energy to a generator 19 and a CPU (Computer Processor Unit) 20, the latter communicating with a computer memory server 21. The energy is transmitted from generator 19 to a modulator 22 feeding resonator 10 to generate a single frequency nanovibration. Switching device 23 intersects between the modulator 22 and the actuator/resonator 10. FIG. 4(b) is a variant of 4(a) except that multiple frequencies are generated.

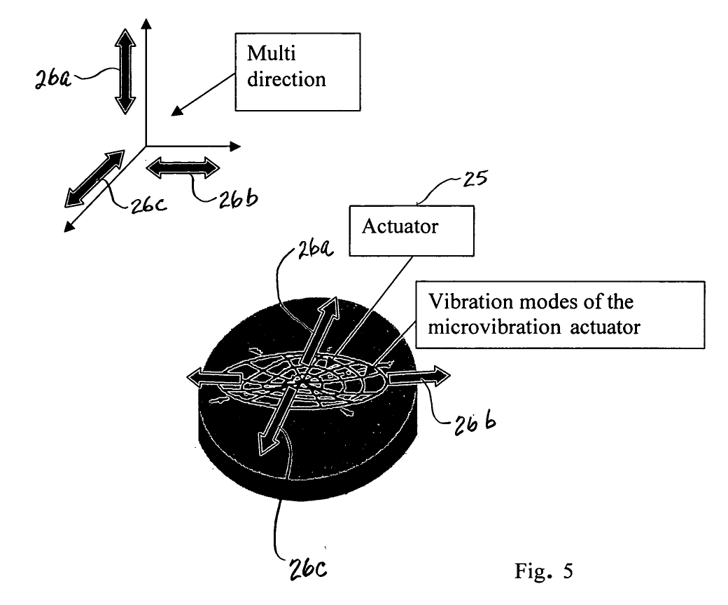

FIG. 5 illustrates a piezo ceramic disk shaped resonator 25. This resonator is activated to vibrate in multi-mode generating multi-directional energy transmissions 26(a), 26(b), and 26(c). These three modes of vibration may respectively be longitudinal, latitudinal, and bending modes.

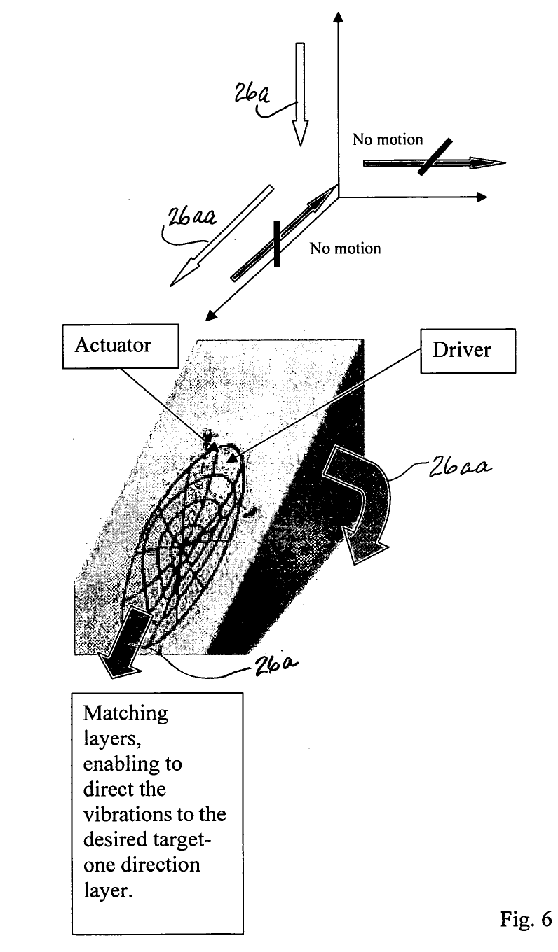

FIG. 6 illustrates a single phase vibrational mode 26(a). Herein, all the available energy is focused in a single direction towards a desired target. During transmission along a natural conduit, the single phase energy may be directed towards or diverted (in total) along a different direction 26(aa). No matter directional shifts, in this embodiment the energy is not dissipated in multi directions at any single point.

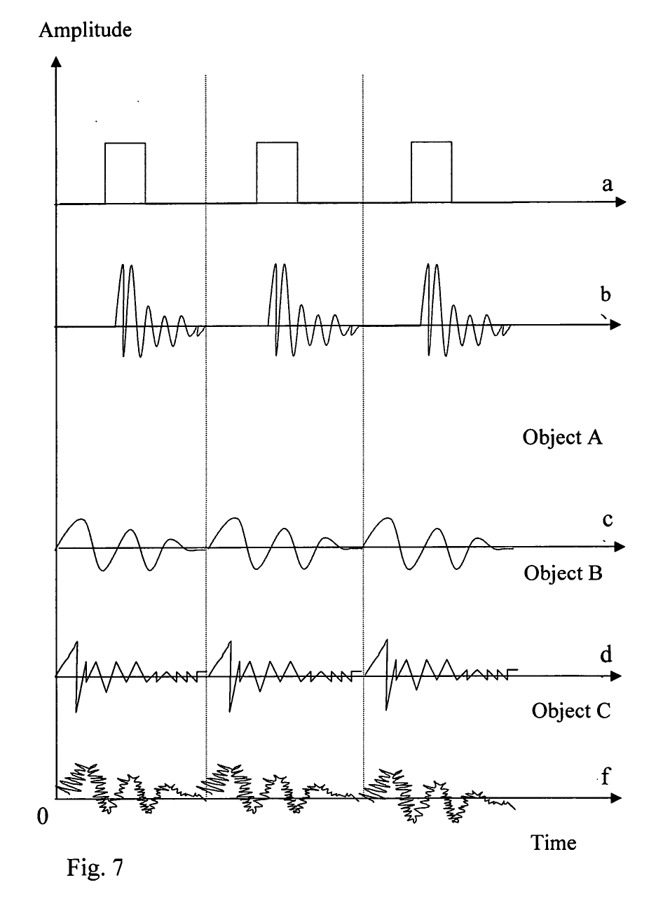

FIG. 7(a) illustrates a single resonator source of energy transmission to objects A, B, and C. FIG. 7(a) is a diagram of electrical signal pulses applied from the driver to the resonator. FIG. 7(b) reflects the amplitude of mechanical vibration of the resonator. FIG. 7(c) reflects vibrational energy impinging onto object A. FIG. 7(d) reflects vibrational energy impinging onto object B. FIG. 7(e) reflects vibrational energy impinging onto object C.

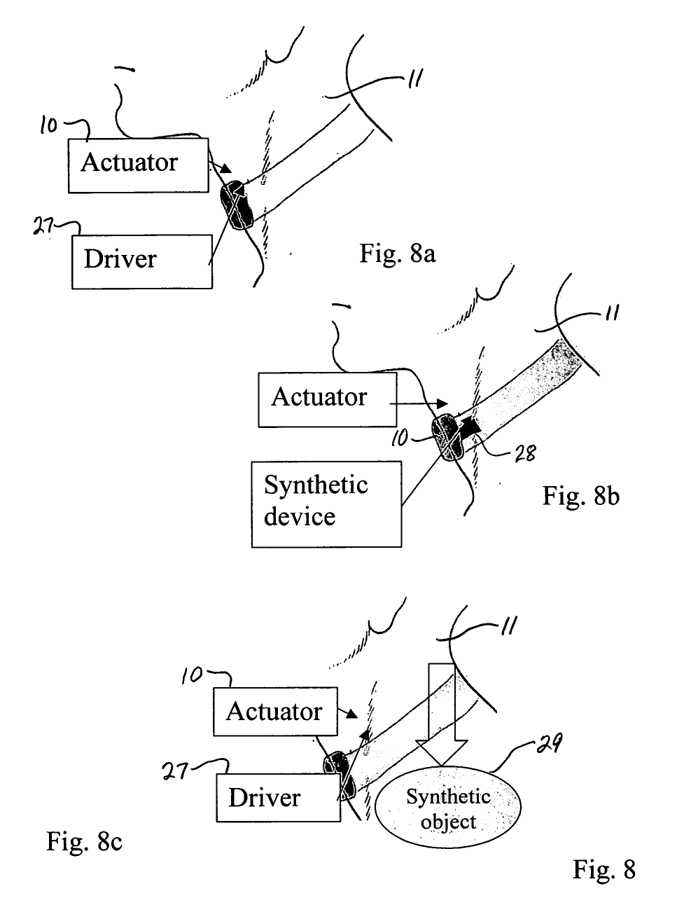

FIG. 8(a) shows one method of attaching the resonator 10 and driver 27 around a neck 11 of a human subject. This embodiment illustrates intimate contact from pressure against the skin by the resonator. FIG. 8(b) is a variant wherein a synthetic device 28 penetrates the skin on one surface and on an opposite surface of the device communicates with the resonator. FIG. 8(c) is a final variant wherein a prosthetic device 29 or other implanted synthetic medical device transmits from the resonator 10 through natural conduits within the body.

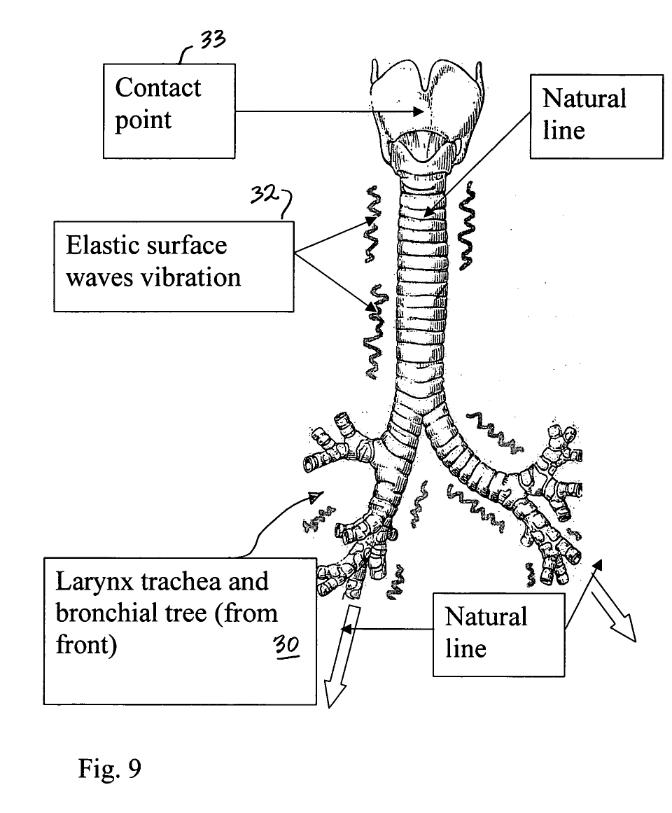

FIG. 9 illustrates sections of the human respiratory system. Therein, the larynx, trachea, and bronchial tree, together referred to as conduit 30, distribute elastic surface wave vibrations 32 to lobes of the lungs. Vibrations 32 originate at contact point 33 representing the Adam's Apple.

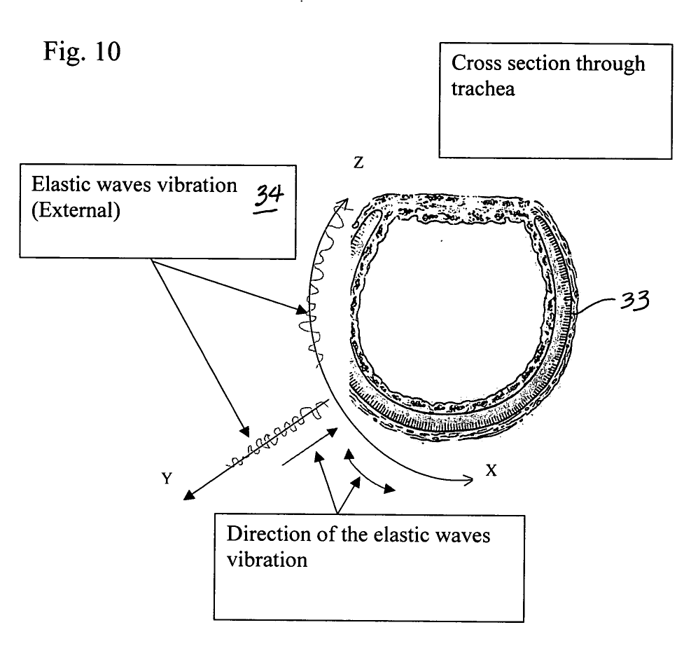

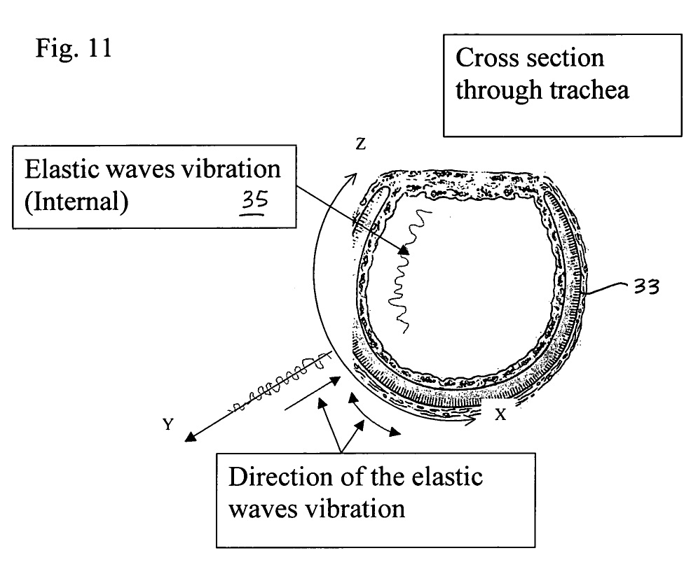

FIGS. 10 and 11 illustrate the application of nanovibrational energy to an external 34 and an internal 35 surface respectively of the trachea 33.

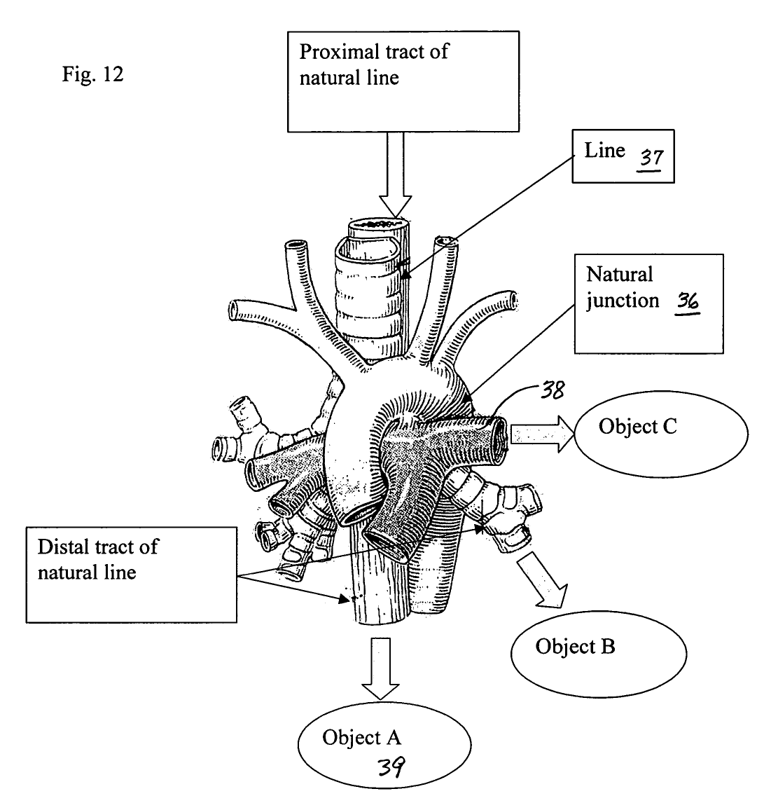

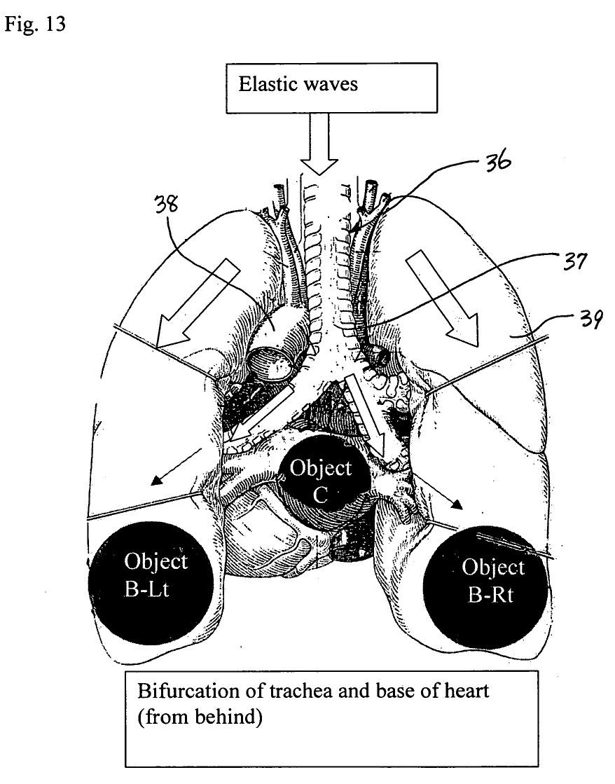

FIG. 12 illustrates the confluence of several natural body conduits lying in intimate contact with one another forming an acoustic junction 36. The acoustic junction enables transmission of nanovibrations from one specific natural conduit to another one. In this figure, the natural conduits are the trachea 37, arteries 38, and lungs 39. A similar representation is found in FIG. 13 except that the latter illustrates bifurcation leading to energy transfer to two targets. Through adjustment, the preferred wavelength of vibration with higher energy quantity (thick arrow) can be transmitted to one direction while the lower energy (thin arrow) to the other direction.

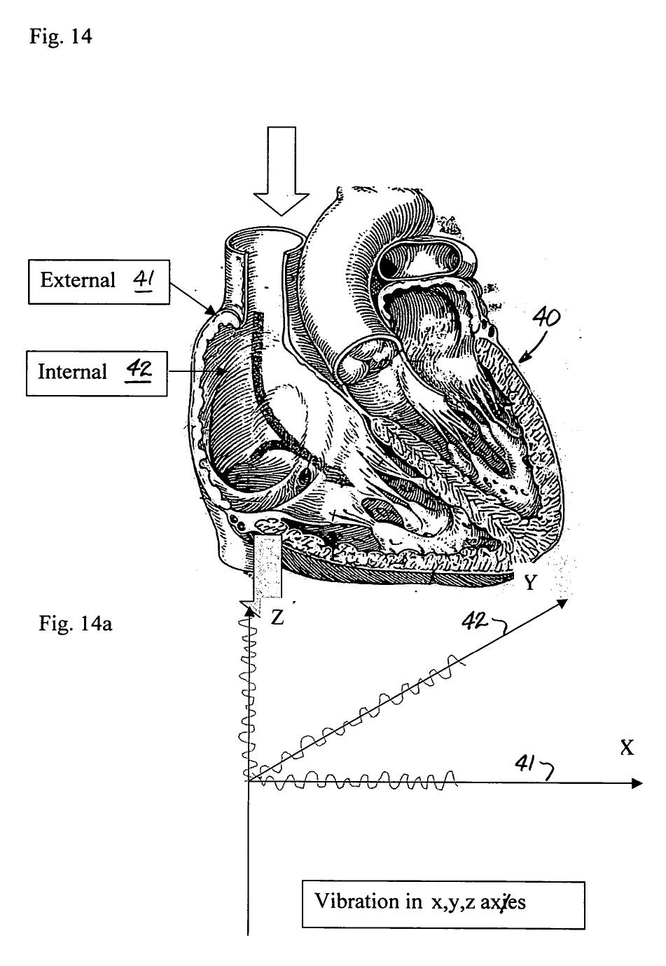

FIG. 14 illustrates a cut-away section of a heart 40. Vibrational energy can be transmitted to an external surface 41 of the heart. Further transmission to an internal surface 42 can be achieved by transverse wave mechanical energy component of the applied nanovibrational energy which crosses the cardiac wall from external to internal surfaces.

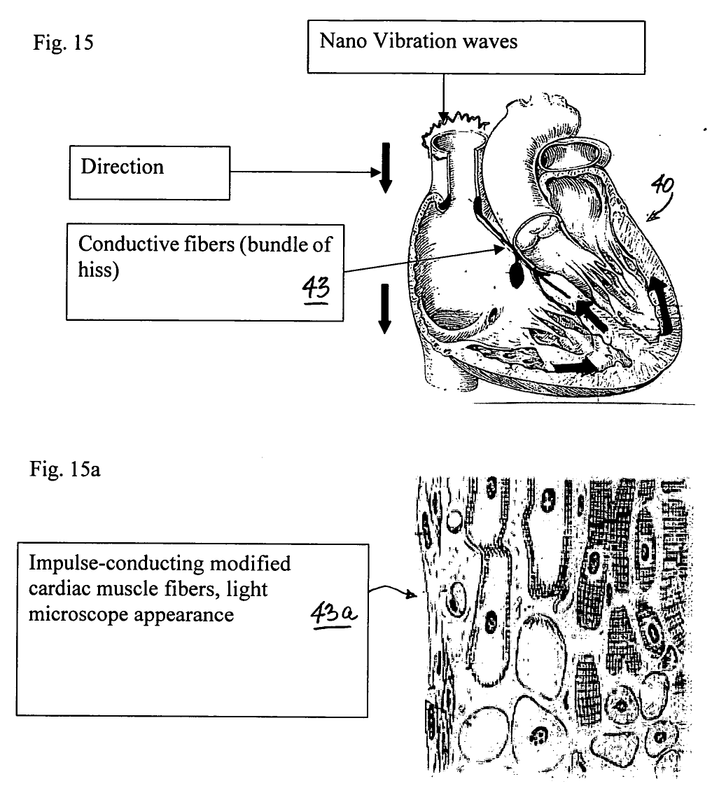

FIG. 15 shows a cross-section of the heart having activated with nanovibrational waves. These waves are transmitted to and through the conductive fiber system 43 constituting heart tissue. Transmission through the conductive fiber system improves transmission by decreasing impedance. FIG. 15(a) is a cross section of conductive fibers 43 as viewed under a microscope.

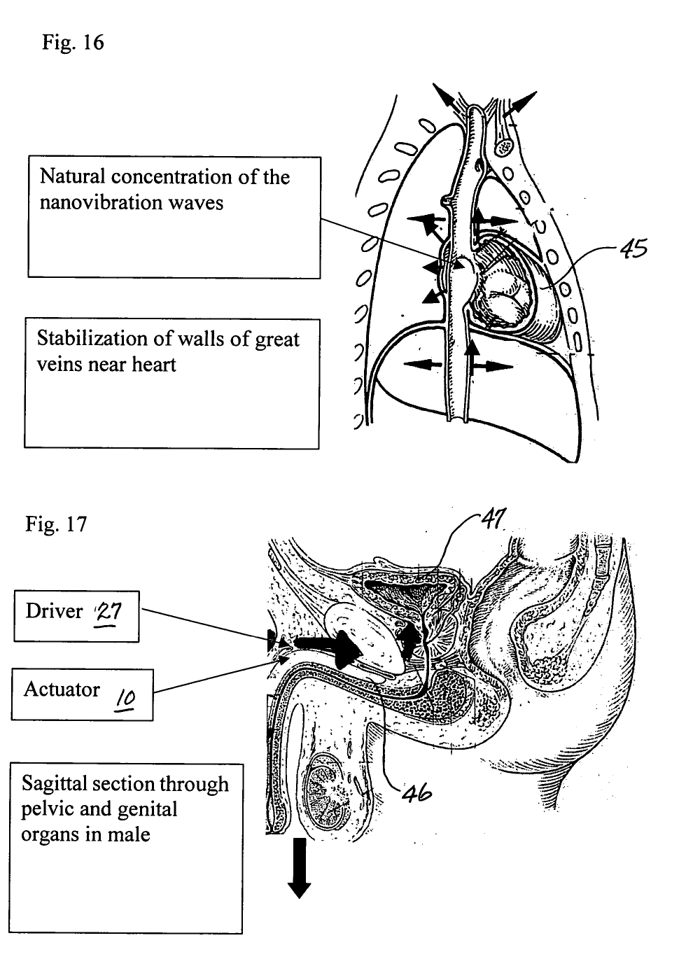

FIG. 16 illustrates the transmission of vibrations to a spherical organ (i.e., the heart) 45. This organ serves as a concentrator of mechanical energy when the organ operates in natural resonance.

FIG. 17 illustrates in cross section the sagittal area through pelvic and genital organs of the human male. Natural conduits and cavities of this urinary system 46 directly transmit the vibrational waves to a pre-selected target organ 47.

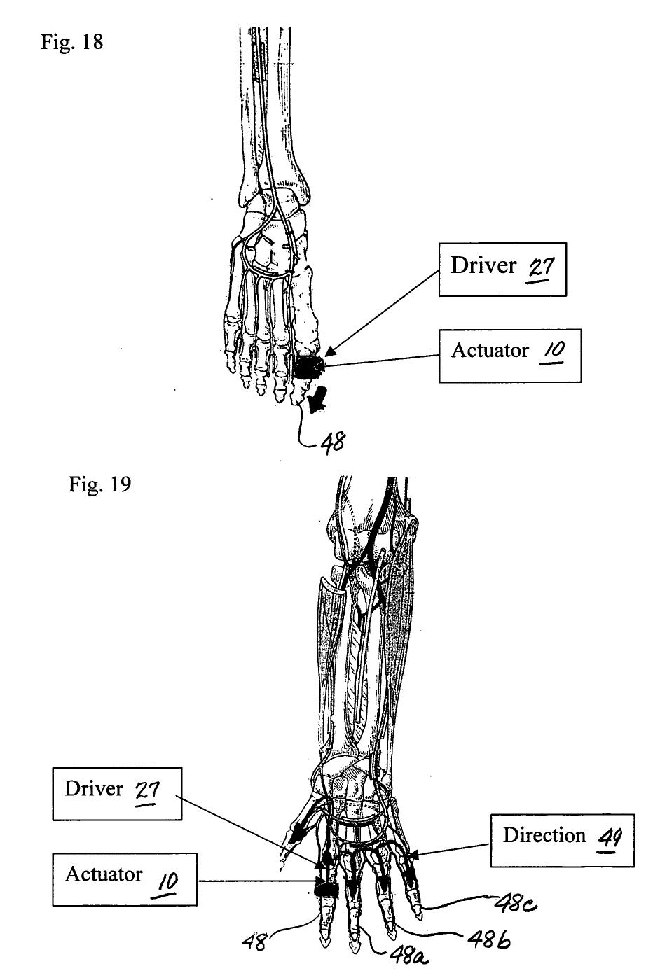

FIG. 18 illustrates a human skeletal hand. Actuator/resonator 10 transmits only localized waves to a proximal area of a finger 48 to which the actuator/resonator 10 is attached.

FIG. 19 illustrates an embodiment wherein localized targeted energy can be confined to a pre-selected area. Herein, nanovibrational energy is transmitted through finger 48 and can selectively be routed into finger 48(a), 48(b) and/or 48(c). Directions of the waves are indicated by arrows 49.

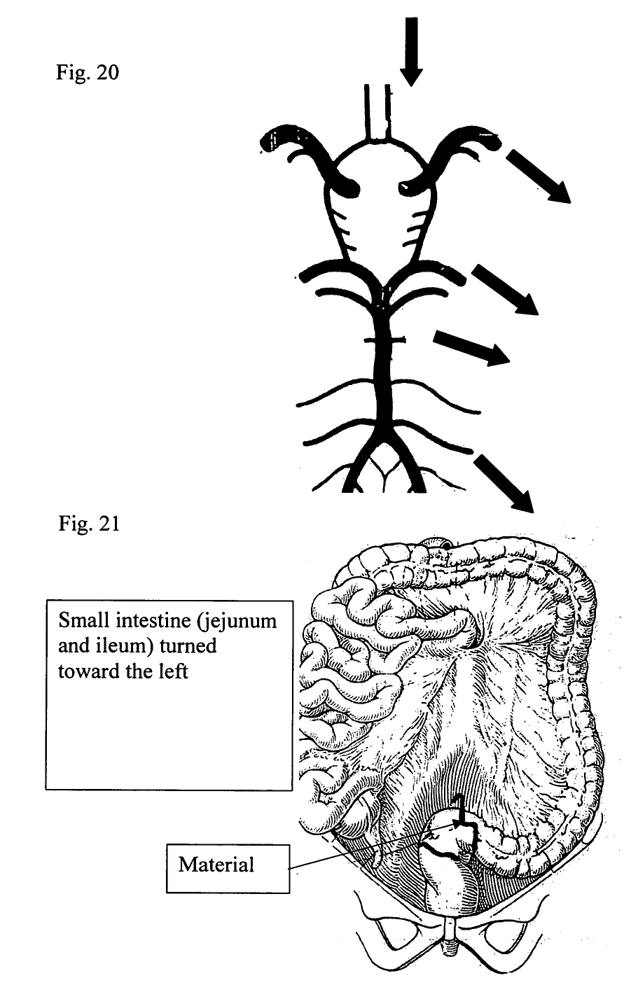

FIG. 20 shows a human intestinal tract. This is a tube-like structure through which special fluids or semi-solids can pass having specific acoustic conductive properties. These fluids and semi-solids serve as intermediary highways for vibrational energy transmission.

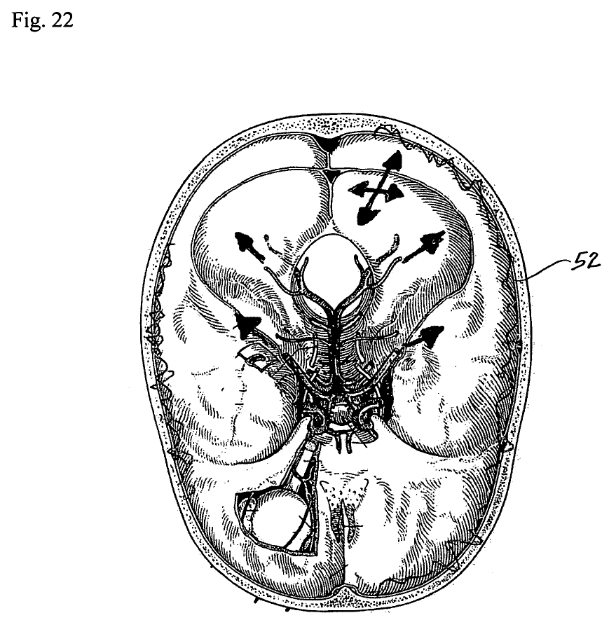

FIG. 21 illustrates a human body organ serving as another natural conduit for nanovibration energy transmission. FIG. 22 illustrates vibrational energy transmission along an internal surface of the cranium 52. Natural conduits in the brain are the membranes covering pia and dura matter, as well as liquid that surrounds the brain.

Only select embodiments of the present invention are illustrated herein. Other aspects of the invention are considered to be within the purview and spirit of this invention and readily applied by those skilled in the art.

1. A method for decreasing amounts of a foreign material attached to internal anatomical surfaces of a mammalian body comprising attaching a nanovibrational energy resonator device onto an external or internal area of the body, the area being proximal to a mammalian conduit system and applying nanovibrational energy thereto.

2. The method according to claim 1 wherein the nanovibrational energy has amplitudes ranging from about 1 to about 50 nanometers.

3. The method according to claim 1 wherein the nanovibrational energy has frequencies ranging from about 0.1 Hz to about 50 MHz.

4. The method according to claim 1 wherein the nanovibrational energy is generated simultaneously with at least two different frequencies.

5. The method according to claim 1 wherein the resonator device is a piezo ceramic material.

6. The method according to claim 1 wherein the resonator device is applied onto a neck of the body over cricoid cartilage commonly referred to as the Adam's Apple.

7. The method according to claim 1 wherein the mammalian conduit systems are selected from the group consisting of respiratory, circulatory, skeletal, urinary, and digestive systems.

8. The method according to claim 1 wherein the device is inserted within the body.

9. The method according to claim 1 wherein the device applies nanovibrational energy to the heart.

10. The method according to claim 9 wherein the nanovibrational energy is applied to myocardial tissue or to valvular cuspids.

11. The method according to claim 8 wherein the device applies nanovibrational energy to a prosthetic member implanted into the body.

12. The method according to claim 1 wherein the nanovibrational energy is applied to lungs of the body.

13. The method according to claim 1 wherein the nanovibrational energy is applied to a mammalian brain.

14. The method according to claim 1 wherein the device is attached to one or more digits of a mammalian hand or foot.
